(19) United States
(12) Patent Application Publication
(10) Pub. No.: US 2022/0402042 A1
(43) Pub. Date: Dec. 22, 2022

(54) MACHINE FOR ADDITIVE MANUFACTURE INCORPORATING MOLDED LAYERS

(71) Applicant: Tritone Technologies Ltd., Rosh HaAyin (IL)

(72) Inventors: Ofer BEN-ZUR, Hod-HaSharon (IL); Eli KEDAR, Beit-Dagan (IL); Alon FELDMAN, Kibbutz Kfar-Menachem (IL)

(73) Assignee: Tritone Technologies Ltd., Rosh HaAyin (IL)

(21) Appl. No.: 17/777,077

(22) PCT Filed: Nov. 13, 2020
(86) PCT No.: PCT/IL2020/051176

§ 371 Date: May 16, 2022

Related U.S. Application Data
(60) Provisional application No. 62/935,658, filed on Nov. 15, 2019.

(51) Int. Cl. B22F 12/84; B22F 12/37; B22F 12/00; B22F 12/53; B22F 12/63; B22F 12/67; B33Y 10/00; B33Y 30/00

(52) U.S. Cl. CPC B22F 12/84; B22F 12/37; B22F 12/38; B22F 12/53; B22F 12/63; B22F 12/67; B33Y 10/00; B33Y 30/00

(57) ABSTRACT

An additive manufacturing machine and associated method for making a part layerwise by firstly using additive manufacture to make a mold to define a space for the layer, and secondly filling the space with a paste to make a layer of the part. The machine comprises a first mold forming station with inkjet nozzles to form the mold using standard 3D printing, and a second paste dispensing station distanced from the first station, with a dispensing die slot for dispensing paste into the space to form a layer. The machine operates on multiple parts simultaneously, each being conveyed along a path through the stations.

### RELATED APPLICATION

This application claims the benefit of priority of U.S. Provisional Patent Application No. 62/935,658 filed on Nov. 15, 2019, the contents of which are incorporated herein by reference in their entirety.

### FIELD AND BACKGROUND OF THE INVENTION

The present invention, in some embodiments thereof, relates to a machine for additive manufacture and, more particularly, but not exclusively, to a machine that prints a mold for each layer of a product or part being manufactured and then fills the mold to form the next additive layer.

Such a manufacturing method is disclosed in International Patent Application No. IL2018/050475, filed 30 Apr. 2018, which teaches inter alia combining Additive Manufacturing with molding techniques in order to build shapes that have hitherto not been possible with conventional molding or machining technologies or in order to use materials that are difficult or impossible to use with known Additive Manufacturing technologies, or to build shapes faster than is possible with known Additive Manufacturing technologies.

Additive Manufacturing is used to make a mold and then the mold is filled with the material of the final product. In some embodiments, layers of the final product are separately constructed with individual molds, where a subsequent layer is made over a previous layer. The previous layer may in fact support the mold of the new layer, as well as provide the floor for the new layer. In examples, two separate applicators are provided, one for printing the mold and having three degrees of freedom as needed for 3D printing, and one for filling the mold after it has been formed.

In one example, inkjet print heads print the mold using wax or any other hot melt or thermo-set or UV cured material, and then a paste is used to fill the mold. Subsequently the paste is leveled using mechanical tools such as squeegee or blade and to fill and level the mold.

IL2019/050957 filed 27 Aug. 2019, discloses that vacuum is used to assist drying and more particularly to carry out hardening of the paste or other filling used in the mold to form the layer. More particularly, at each layer, the mold is formed and then filled with a paste or other substance, and then the newly filled layer surface is placed in a vacuum so that the pressure quickly falls to change the boiling points of the liquids in the paste forming the layer. The liquids thus evaporate to harden the paste to rapidly form a hard layer. After hardening, the vacuum is released, and the volume is vented.

Not all shapes are self-supporting, and U.S. Provisional Patent Application No. 62/780,273, filed 16 Dec. 2018, discloses a method in which sintering supports are manufactured in the same processes as the components requiring sintering. In an example, both the component and support may be provided in an integrated process that includes additive manufacturing. Thus, the mold and support are both manufactured using 3D printing techniques, to produce a supported shape, and the mold is then filled with a paste etc., which is dried.

In U.S. Provisional Patent Application No. 62/873,909, filed 14 Jul. 2019, a layering device is disclosed whose aim is to fill the mold and to eliminate or significantly reduce a separate smoothing stage in the formation of each layer. This is achieved by setting a blade or squeegee that spreads the paste to the same plane defined by the roller that smooths the mold.

Thus, a roller may be used to press the mold. An applicator then applies paste within the mold and a blade is used to spread the paste. The blade is adjusted to be at the height and orientation of the roller so that both the roller and the blade define the same plane in the mold. The roller is thus combined with a paste applicator and the blade to form a layering device, which may serve as part of a 3D printer or additive manufacturing device. The height of the paste applicator may be coordinated with the roller and the blade.

The blade may accordingly be mounted on the same mounting as the roller to form such a layering device, and either or both of the blade and the roller may have provision for micro-adjustments. The applicator may be a slot die that applies paste over a preset width, or one or more point dispensers that apply paste at specified points. In order to fill mold shapes the point dispensers may be moved from side to side.

In the mounting, if the height of the roller is changed, the height of the blade is changed at the same time. Relative movements between the product or part being printed and the single mounting holding the blade and the roller thus do not affect the plane that the roller and the blade both define together.

It is noted that three processes of pressing of the mold after printing, applying the paste and spreading of the paste inside the mold, are carried out in a single pass at a single location. Optionally a further process of smoothing of the paste may be carried out.

However, additive manufacturing is notoriously slow relative to other manufacturing techniques, since each layer is very thin and a large number of layers is needed to complete a part. Consequently, despite much hype, additive manufacture has not managed to make serious inroads into mass production and has generally been reserved for prototyping and small scale production.

### SUMMARY OF THE INVENTION

The present embodiments aim to provide a machine that can improve manufacturing throughput, in particular using the mold-filling variant of additive manufacturing. To date, additive manufacture has used a single location at which a single product is gradually built up layer by layer. The present embodiments provide a manufacturing process that uses different stations for different parts of the process and thus allows for several items to be manufactured in parallel on a single machine. The machine may be closed loop or linear.

According to an aspect of some embodiments of the present invention there is provided an additive manufacturing machine for making a part layerwise by firstly using additive manufacture to make a mold to define a space for the layer, and secondly filling the space with a paste to make a layer of the part, the machine comprising:

a first, mold forming, station with nozzles configured to form said mold; and

a second, paste dispensing, station distanced from said first station with a dispensing die slot for dispensing paste into said space, the machine being configured to operate on a plurality of parts simultaneously, each being conveyed along a path through respective ones of said stations.

Embodiments may comprise a frame, the stations being fixed over said frame.

In embodiments, the stations respectively form bridges over said path between a first station side and a second station side and said fixing is at said first and second station sides.

In an embodiment, said paste dispensing station comprises a roller preceding said dispensing die slot, and a cutter following said dispensing die slot, the roller configured for leveling said mold to a predetermined level and said cutter being configured to level said paste, the roller and the cutter being mounted at a same level.

In an embodiment, said stations are arranged around a circumference.

In an embodiment, said stations are arranged such that a rotation of a part around said stations provides a whole number of completed layers for said part.

Embodiments may comprise a rotating table for carrying manufacturing trays between said stations.

In an embodiment, said rotating table is connected to said frame via a central axis, the central axis providing rotation to said table.

In an embodiment, said rotation is controlled by an indexer to stop said table when said parts are aligned at respective stations.

In an embodiment, a circumference of said table is supported vertically from said frame.

In an embodiment, said circumference of said table comprises rail, and said frame comprises cam followers extended upwardly towards said rail, thereby to provide said vertical support.

In an embodiment, said cam followers are aligned with said stations, thereby to securely hold said table at each station vertically

Embodiments may include one or more additional paste dispensing stations.

Embodiments may comprise a drying station.

Embodiments may comprise a vacuum station.

Embodiments may comprise an observation station.

In an embodiment, said observation station is configured to control said machine to remove a layer found to be damaged, for said layer to be rebuilt.

In an embodiment, said stations are aligned on a linear path, the linear path traversed by a linear conveyor.

Embodiments may vary the height of the mold so that different layers are of different thicknesses.

Embodiments may make more than one layer in a single rotation of the timetable.

Embodiments having at least one additional paste dispensing station, may dispense pastes of different compositions for different parts or may form parts made of compound materials.

According to a second aspect of the present invention there is provided a method of additive manufacture comprising:

Providing a pathway,

Providing stations along said pathway,

Providing build trays,

Causing said build trays to traverse said pathway while pausing at each station,

Carrying out different stages of additive manufacture at respective ones of said stations in parallel during said pausing, such that a part traversing said pathway is built up layerwise.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram showing a view from above of a machine for additive manufacture inside a covering, according to embodiments of the present invention;

FIG. 2 is a perspective view of a frame for the machine of FIG. 1 with a rotatable axis for mounting a turntable;

FIG. 3A is a perspective view of the frame of FIG. 2 with a turntable mounted thereon;

FIG. 3B is a view from above of the turntable of FIG. 3A;

FIG. 4 is a is a simplified diagram of a build tray and slidable mounting according to embodiments of the present invention;

FIG. 5 is a perspective view from above of the turntable with supports from the frame to the turntable periphery;

FIG. 6 is a detail of the cam follower structure of the support of FIG. 5;

FIG. 7 is a perspective view of the detail of FIG. 6;

FIG. 8 is a perspective view according to FIG. 3, showing stations installed around the turntable;

FIG. 9 is a view from above of the turntable with stations installed according to FIG. 8;

FIG. 10 is a side view of the paste dispensing unit, of FIG. 9;

FIGS. 11A and 11B are side views of the vacuum station of FIG. 9 in withdrawn and vacuum positions respectively;

FIG. 12 is a perspective view of the inspection station of FIG. 9;

FIG. 13 is a simplified diagram showing an alternative embodiment of the present invention using a linear layout; and

FIG. 14 is a simplified diagram showing an alternative embodiment of the present invention using multiple number of linear axes.

### DESCRIPTION OF SPECIFIC EMBODIMENTS OF THE INVENTION

The present invention, in some embodiments thereof, relates to a machine for additive manufacture and, more particularly, but not exclusively, to a machine that prints a mold for each layer of a product or part being manufactured and then fills the mold to form the next additive layer.

According to the present embodiments there is provided an additive manufacturing machine and associated method for making a part layerwise by firstly using additive manufacture to make a mold to define a space for the layer, and secondly filling the space with a paste to make a layer of the part. The machine comprises a first mold forming station with inkjet nozzles to form a mold in three dimensions using standard 3D printing, and a second paste dispensing station distanced from the first station, with a dispensing die slot for dispensing paste into the space to form a layer. The machine operates on multiple parts simultaneously, each being conveyed along a path through the stations. The additive manufacturing machine may be based on either a linear track or a rotating plate design with a closed loop track, and more particularly with an endless conveyor. Build trays move along the track to stations that carry out different parts of the additive manufacturing process. The endless conveyor concept allows building on several trays in parallel, hence increasing the throughput dramatically.

There are at least the following stations: a mold printing station, and a paste deposition station. There may be provided in addition, a drying station, a vacuum station, an optical inspection station, and a station for natural or enhanced cooling. If not provided as separate stations, then some or all of the latter functions may be integrated into say the paste deposition station. The sequence of stations may be provided once, twice or more along the track, according to the amount of throughput that is required, so that two, three or more layers could be added to the part for a single rotation. As discussed elsewhere herein, one or more paste deposition stations may allow for production using different materials at the same time.

The process may be based on the technology outlined in the background, namely Inkjet printing of a mold, and filling the mold with a paste that includes ceramic or metal, typically as a powder with a water based or solvent based binder. The process of adding a layer is repeated until the product or part is complete and various finalization processes are carried out such as removing the wax of the mold, and, and then debinding and sintering to leave a dense product or part.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

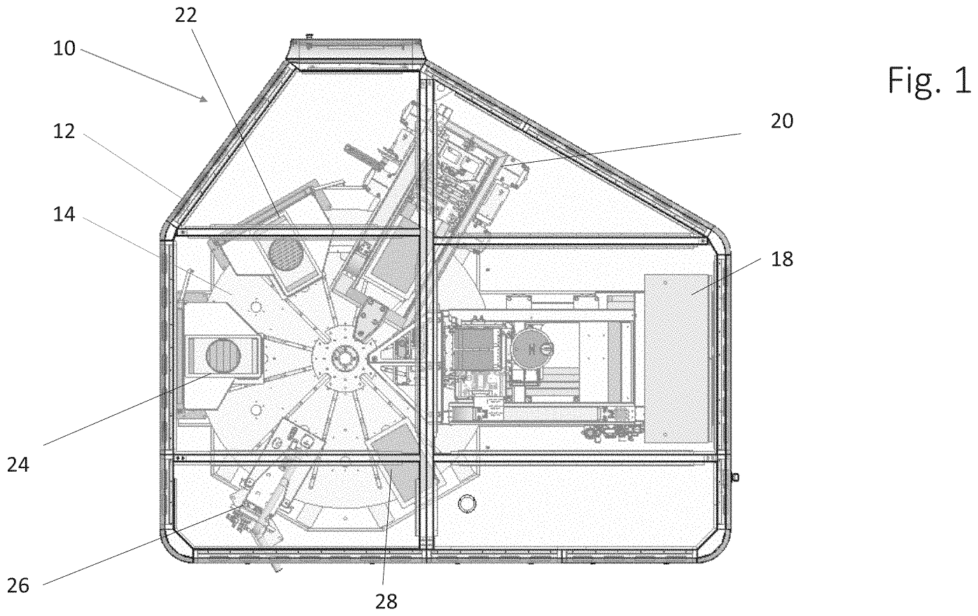

Referring now to the drawings, FIG. 1 illustrates an additive manufacturing machine 10 according to embodiments of the present invention. The machine is contained in external coverings 12 and comprises a round turntable 14 and build trays located on the turntable which rotate with the turntable. According to the embodiment shown in the drawings the rotation is counterclockwise. Stations are located around the turntable and are discussed in greater detail below, but are briefly mentioned now. A 3D printing station 18 builds a mold so as to define a space within for filling. A paste dispensing station 20 fills the space with paste and provides a smooth surface. Drying stations 22 and 24 provide natural and forced hot drying for the part respectively after application of the paste. Vacuum station 26 provides vacuum to further dry and harden the part and observation position 28 checks the layer for inaccuracies. If inaccuracies are spotted then, in embodiments, the layer may be removed and reapplied.

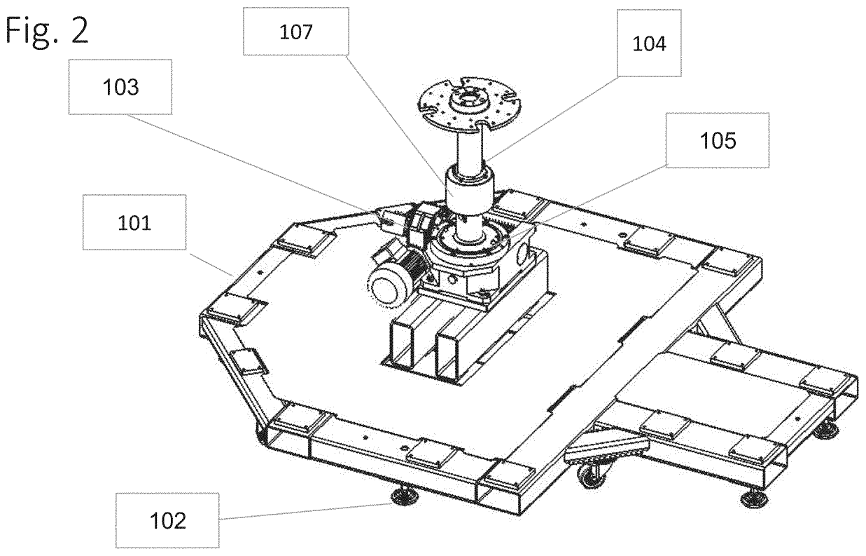

Referring now to FIG. 2, and the machine is based on a chassis made from rigid welded bars 101 supported on leveling pads 102. On top of chassis 101, a motorized indexer system 103, including a motor, is installed. As an alternative to an indexer, any other controlled rotating stage, for example that known in the industry such as a direct motor system, or a pinion table and other conventional rotating mechanisms may be substituted. A central shaft 104 is connected to the indexer 103 or to the chassis 101 and extended upward. The central shaft 104 is static while plate 105 is rotated by the indexer 103.

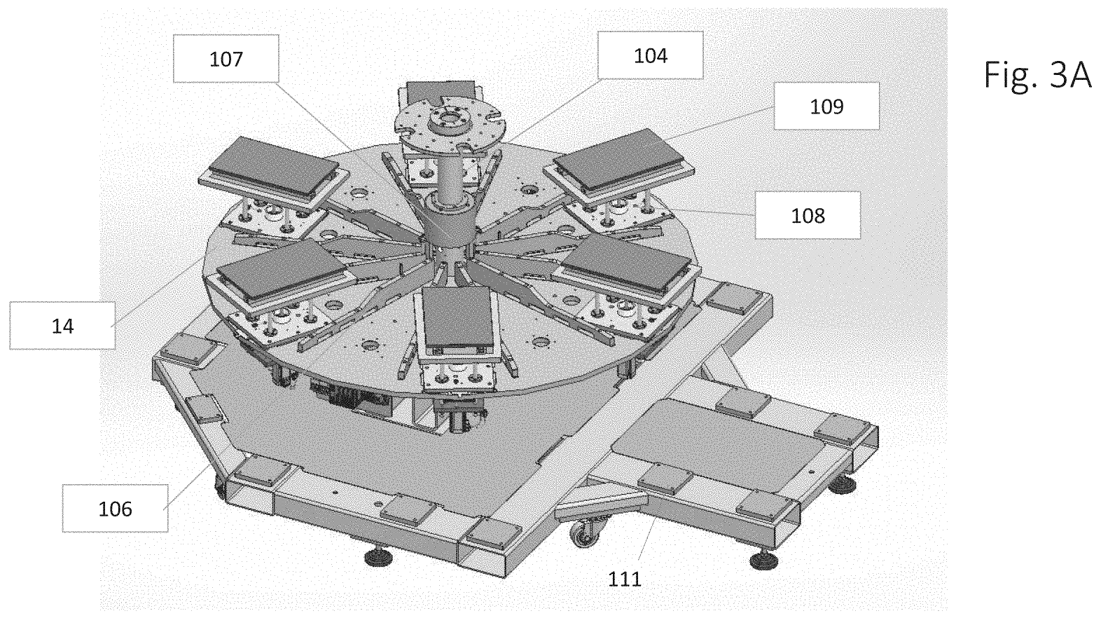

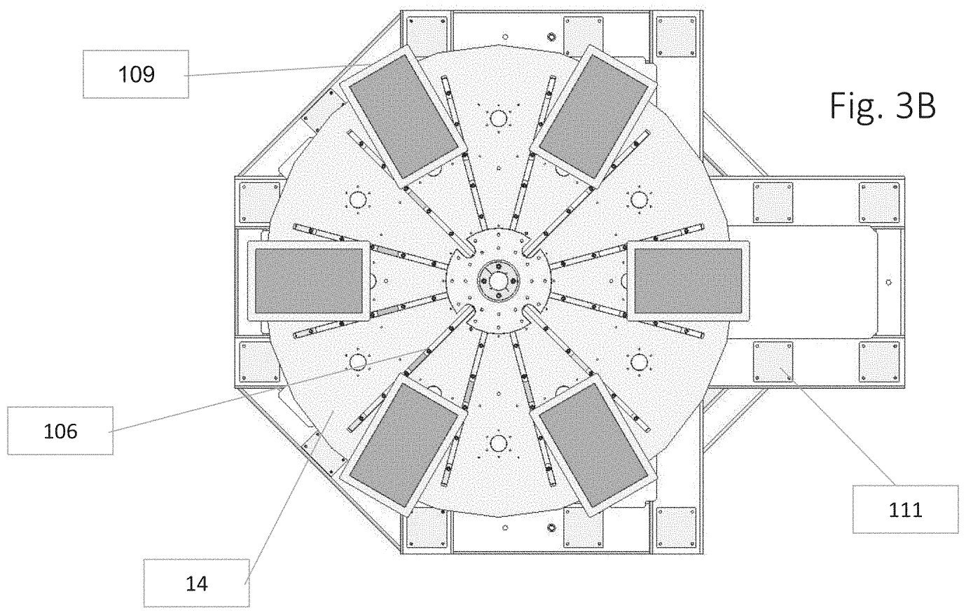

Reference is now made to FIGS. 3A and 3B which are upper perspective and upper views respectively of the assembly on the chassis. Above the indexer upper plate 105, a large diameter circular turntable 14 is attached, which rotates together with plate 105. Turntable 14 is stiffened by ribs 106 as a first measure to prevent sagging.

The systems on the turntable may require an on-board electrical supply for power and communication. A slip ring system 107 such as the Moflon MT Series may thus be installed. In the slip ring system, a static ring is attached to shaft 104 and a movable ring is attached to plate 105 or to turntable 14. Slip ring system 107 allows current from an electrical supply or electronic sources to be distributed to rotating electronic controller and motors that rotate with turntable 14.

Along turntable 14, controlled linear Z stages 108 are provided for the build trays. The Z axis allows the stage to move vertically during the building process of the parts.

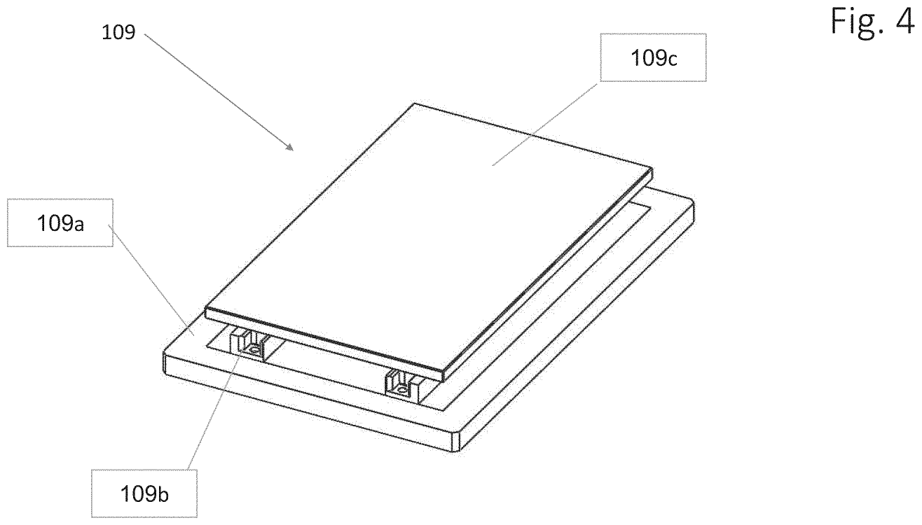

Reference is now made to FIG. 4, which illustrates an exemplary construction for a stage for a build tray according to the present embodiments. On top of each Z stage as described above, a process Table Assembly 109 is attached.

The table Assembly 109 includes a flat plate 109a with a sealing surface, slotted bars 109b to allow for horizontal sliding and a process tray 109c on which the additive manufactured part is to be built.

Each of the trays 109c may be disconnected from Assembly 109 to allow the part to be removed from the machine for later stages of the process, say to remove the mold etc.

Process stations may be located along and outside Turntable 14. The process stations may perform different ones of the processes that build the parts on trays 109c. Indexer 103 rotates the trays by a predetermined angle after each operation and then locks all of the trays in place at the following station for the next operation. In this way several trays may be built up in parallel, rather than being manufactured in series. Throughput is correspondingly increased. In an embodiment, a full rotation of the turntable (360 degrees) represents one complete layer build of a part. In other possible embodiments, a full rotation may represent two, three or more layers.

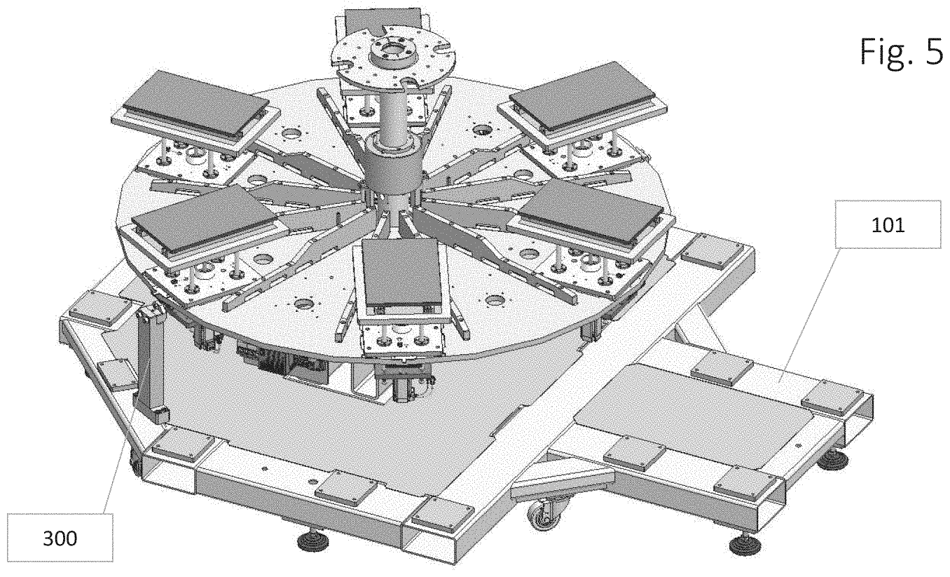

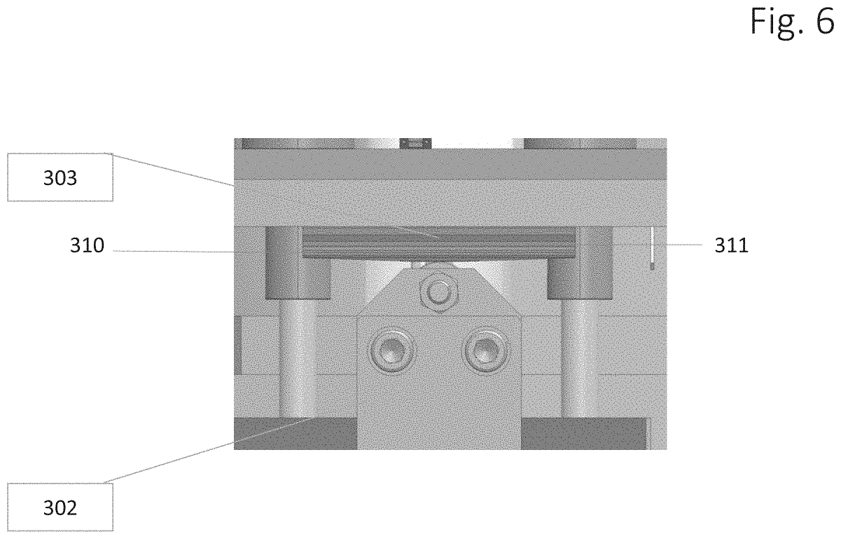

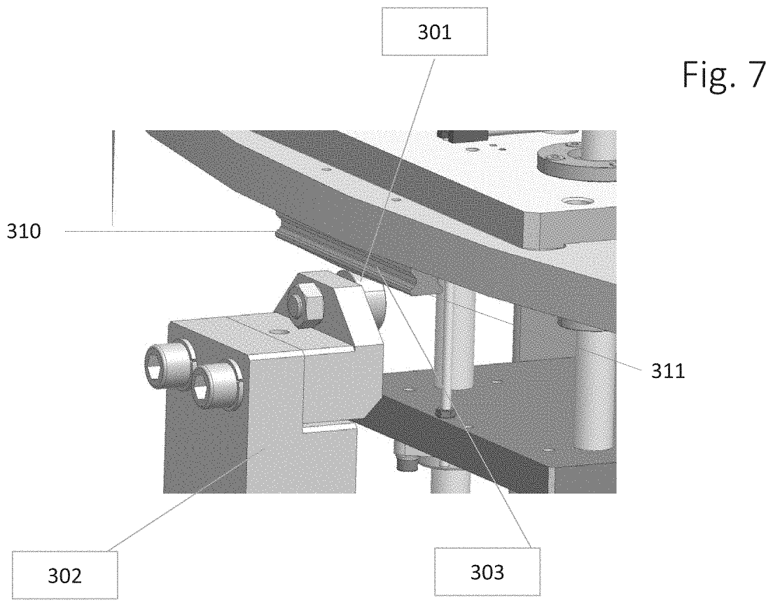

Referring now to FIGS. 5, 6 and 7, in order to eliminate deflection of turntable 14 due to weight of parts or external forces, cam follower mechanisms 300 are attached to chassis 101 to support the lower surface of turntable 14 at predetermined locations according to the level of accuracy required. Any deflection may lead to a non-accurate build. The cam follower mechanisms 300, which may be located at the respective stations, may provide the necessary support to prevent table deflections without interfering with the rotation of the turntable.

In mechanism 300, cam follower 301 is connected to bar 302 that is fixed to the chassis. The Cam follower 301 may be a roller bearing. The facing surface in touch with the cam follower is attached to turntable 14. The facing surface is in the present embodiment a hardened and flat linear rail 303, which may be made from high chrome steel alloy. The rail 303 may be machined in a way that allows the cam to gradually come into contact with the rail and eliminate any shock at the point of engagement, but provide support to keep the plate at the designed level at the station. Such machining may be provided for example by chamfering the rail at ends 310 and 311.

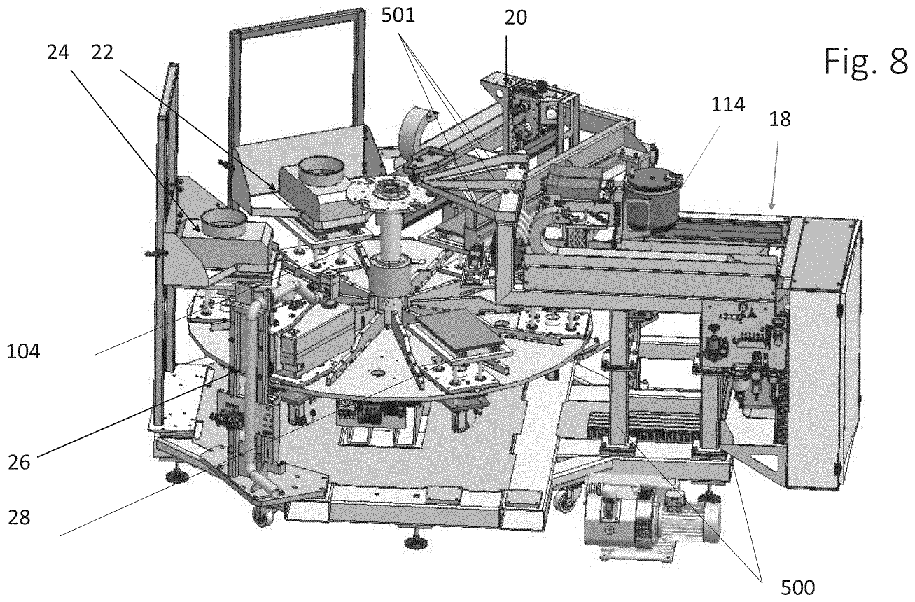

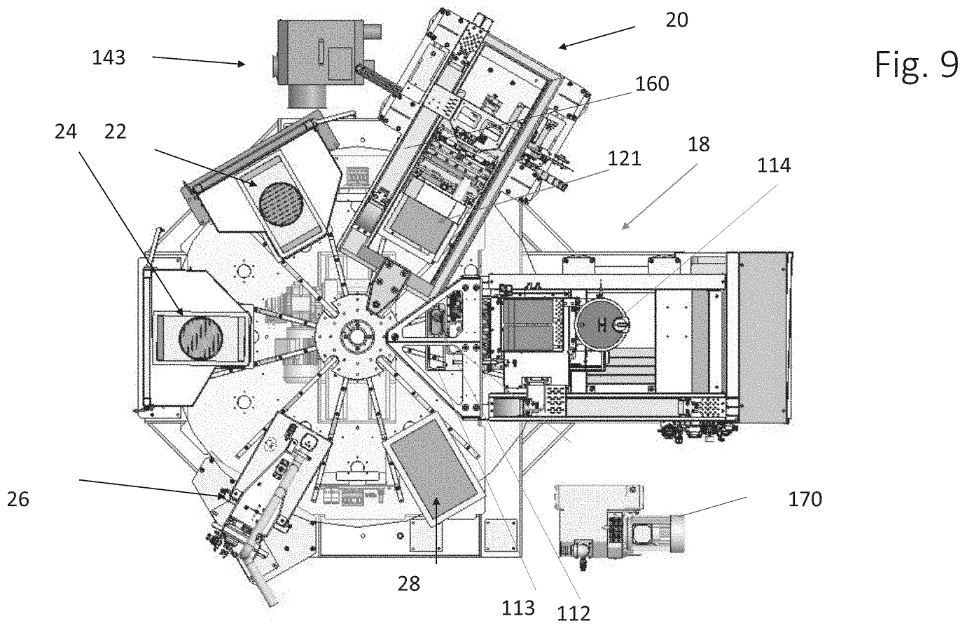

Reference is now made to FIGS. 8 and 9, which show details of two of the stations around the closed loop. Mold building Station 18 is an inkjet printer, jetting solid ink or any other ink on top of the tray to use additive manufacture to form a mold. The mold building station allows building of layers of greater or lesser thickness, and any part may include layers of different thickness. More particularly, it is possible to change the mold height and thus get a different Z resolution of the layer. Wherever the nature of the design allows, it saves time to print thicker layers and, on the other hand, also allows production of parts that are finer where needed by using thinner layers. The mold height may be determined by changing the print resolution in XY coordinates, so that for example—1800×1800 dpi is thicker than 1200×1200 dpi since more drops of solid ink are jetted per square inch.

It is additionally noted that during the drying process of the paste, water and solvents evaporate, and may reduce the height of the paste layer. In certain cases the reduction may be as much as 20% for example, or even more. Thus, if the accuracy required for the layer is very high, then the filling process may be repeated within the same mold. Such may particularly be necessary for the final layer of a part. Specifically the filling process is repeated followed by drying, vacuum and inspection.

The mold building station 18 is peripherally supported via supports 500 on accurate flat surfaces 111 on chassis 101 (see FIGS. 3A-B). The station 18 is centrally supported on shaft 104 via beams 501 so that it is held steady across its length to provide stable and accurate positioning. In the present embodiment, a trio of beams 501 is used to provide stable anchoring.

Inkjet printheads 112 may be mounted on head plate 113 to precisely apply drops of solid ink based on say melted wax, to defined locations on the tray to build up the mold. Ink flows from the main ink reservoir 114 to the printheads. Head plate 113 is movable in two non-parallel and typically orthogonal horizontal directions, for example, the long axis of the tray and the short axis of the tray, to achieve freedom to deposit drops anywhere required over the tray. It will be recalled that the tray itself moves in the vertical direction so that the layer to be printed is always at the same height.

According to one embodiment, the head array is movable along the length of station 18 by a linear motor system (not shown) and in a perpendicular direction by a ball screw system (not shown), in order to print the mold.

Thus, in the embodiment, mold printing station 18 is suspended as a bridge over the path of the trays as they pass, supported on either side and providing printing heads that are able to move in the X and Y directions.

Paste station 20 is likewise suspended as a bridge over the tray path, being attached to main chassis 101 via supports—not shown—and also attached to shaft 104. Paste station 20 may be located one position further around the circumference of the turntable 14 after the mold printing station in the indexer rotation direction.

Station 20 includes a motorized linear axis 160 along the radius of the indexing system along which an application unit 121 may move back and forth. As desired, multiple paste stations may be provided, for example when the part requires more than one material, so that more than one different paste is needed. In this way, parts with multiple materials may be constructed Parts from different materials can also be prepared, for example on different trays.

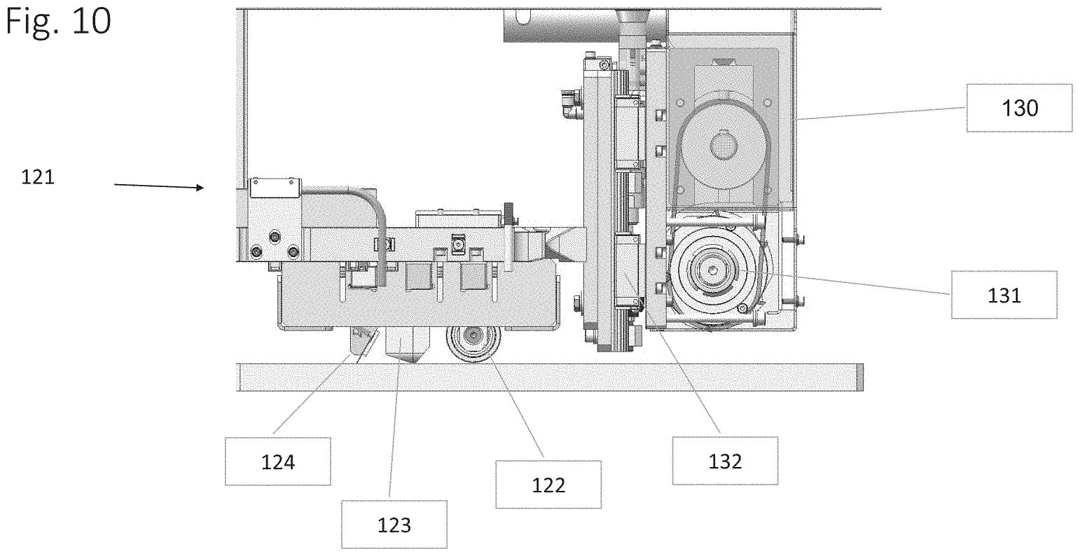

Reference is now made to FIG. 10, which is a side view of application unit 121, which is mounted on paste application station 20. A roller 122, Die Slot 123 and a blade 124 provide a paste filling mechanism, for filling the space inside the mold walls with paste. More particularly, roller 122 presses the printed mold to ensure a flat and accurate mold surface. Die Slot 123 applies paste by pressure or by other means such as peristaltic pump, movable syringe etc.

Then, blade 124 removes the excess paste from the layer mold surface. Further details of the process are to be found in applicant's co-pending application No. 62/873,909, filed 14 Jul. 2019, discussed briefly above, the contents of which are hereby incorporated herein by reference.

In addition, a cutter Assembly 130 may also be installed in unit 121. Cutter Assembly 130 may comprise a circular Cutter 131 such as a wood planer. The cutter is motorized by a spindle or by any controllable circular motor. Cutter 131 is attached to a vertical axis 132 that allows for lifting of the cutter while paste is applied, to eliminate collision between the cutter and the part. Axis 132 may be a pneumatic linear stage or a motorized stage. On request, the building tray may move vertically to an exact required position as the cutter moves down to a cutting position. Cutting Assembly may move along the longitudinal axis of the station 20 to polish the existing surface, say prior to laying down a new surface, or to remove undesired layers.

Returning now to FIGS. 8 and 9, and drying Stations 22 and 24 are the following stations encountered by the tray in the part preparation process. At these stations, the part undergoes a process of natural drying or forced drying. Forced drying may include any known drying process such as hot air drying, IR drying, Microwave drying etc. In one embodiment, drying stations 22 and 24 are forced hot air drying stations in which a hot air blower 143 forces air towards the part. According to one embodiment, the user may choose to turn the air off in any of stations 22 and 24 and then the process at the station becomes natural drying, meaning drying based on natural air convection. The tray stays in position for a fixed time, allowing the water or solvents to undergo forced or natural evaporation from the last filled layer. Pipes (not shown) lead from the blower 143 to the relevant stations. In an embodiment, the temperature of the hot air is below the wax melting point, since the previous layer mold structure may still be needed.

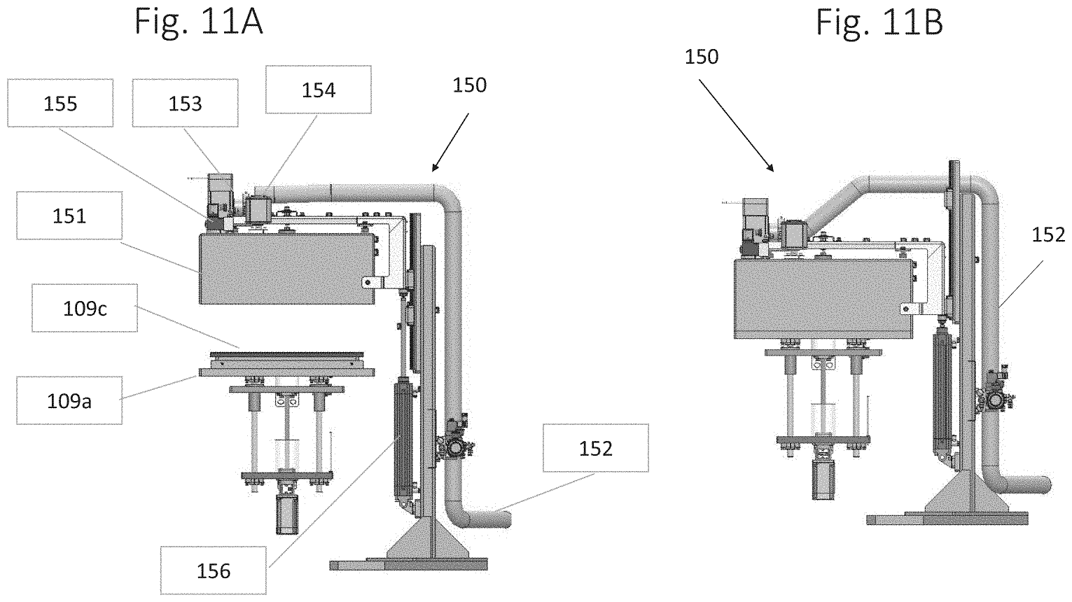

Station 26, which here immediately follows the drying station, provides for vacuum drying and hardening. The vacuum hardening process is described in applicant's copending international patent application no. IL 2019/050957 filed 27 Aug. 2019. FIGS. 11A and 11B show side views of the vacuum station. FIG. 11A shows the vacuum chamber raised before or after use and FIG. 11B shows the chamber in use, applying vacuum to dry the current part. More particularly, in hardening station 26, a vacuum cap 151 covers flat plate 109a so that the cap volume encloses process tray 109c and the part being built therein. Vacuum cap 151 is then pumped to evacuate air to a specific vacuum level. The volume remains under vacuum for a predefined time. Vacuum cap 151 is a box with sealing material at the attachment area to flat plate 109a.

A vacuum pump 170 is connected by hose 152 to main valve 153. The vacuum pump 170 may be for example a one stage or two stage rotary pump.

The vacuum process may be monitored by vacuum sensor 154. Vent valve 155 is for example, a normally closed pneumatic valve, connected to vacuum cap 151. Pneumatic actuator 156, moves cap 151 up and down between the open and closed positions exemplified by FIGS. 11A and 11B respectively.

Once the process tray is locked in position under the vacuum station 26, pneumatic actuator 156 moves cap 151. The cap attaches to flat plate 109a, and main valve 153 is set to open position for the volume to be pumped. The vacuum level as indicated by vacuum sensor 154 is monitored electronically, for example using an on-board computer. After the vacuum drying process has been accomplished, the main vacuum valve 153 is closed. The vacuum pump may in an embodiment keep operating, so as to be prepared for the next tray. At this point, vent valve 155 is turned on to allow ambient air flow into the pumped volume. Gradually, pressure in the volume reaches atmospheric or ambient pressure. Once the ambient pressure is reached, pneumatic actuator 156 lifts the cap to release the tray and part and allow tray movement to the next position under control of the Indexer. In one embodiment, pressurized air is provided to the volume through vent valve 155 to accelerate the venting process.

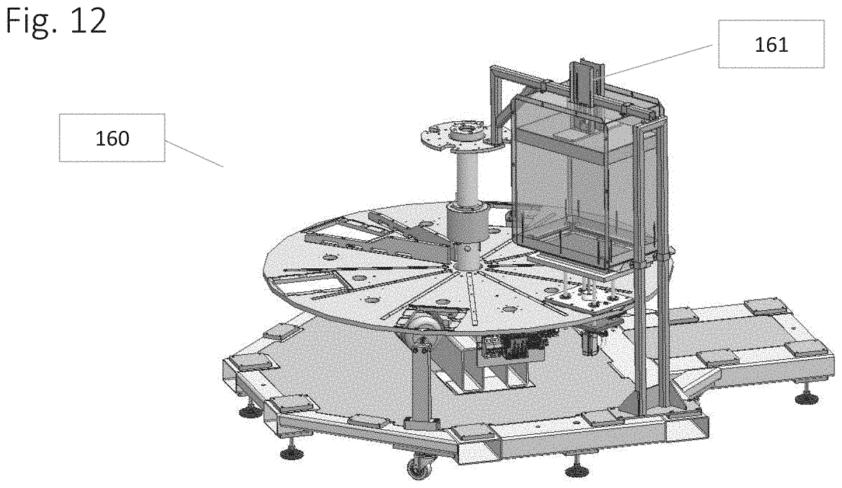

Again returning to FIGS. 8 and 9, and inspection station 28 is the next station reached by the tray around the circumference of the table. Station 28 is shown in greater detail in FIG. 12 and includes a camera 161, typically a digital camera, that compares the layer, after having been hardened, to the layer image. Any defined deviation detected by the camera and associated image processing is analyzed and dealt with according to predefined rules. If the layer is damaged, a correction may be made by moving to the cutter location and removing and remaking the last layer.

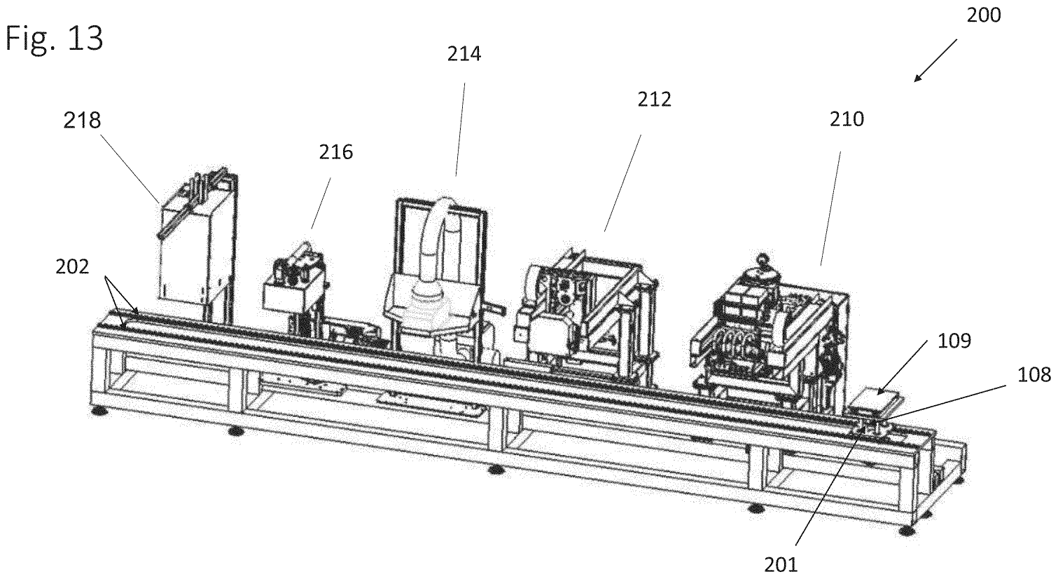

Reference is now made to FIG. 13, which illustrates an alternative embodiment of the additive manufacturing machine of the present invention. Additive manufacturing machine 200 is a linear additive manufacturing machine. Machine 200 is based on a plate 201 that moves back and forth accurately on rails 202. The plate may be attached to a linear motor or a ball screw or any other known conveying method.

On plate 201, a vertical linear Z stage 108 allows the part to be raised and lowered so that the layer to be manufactured is always at the same height. On top of Z stage 108, a process Table Assembly 109 is attached, which may conveniently be the same as that illustrated in FIG. 4 and discussed hereinabove to provide a build tray.

As shown in FIG. 4, Table Assembly 109 includes a flat plate with sealing surface 109a, slotted rails 109b, and a process tray 109c able to travel on the rails and on which the product or part is to be built.

Tray 109c may be pulled out of Assembly 109, for example to remove the part for later processing after manufacturing is complete. As mentioned above, after printing the part is preferably only moved together with the tray.

Process stations are located along rails 202. Printing station 210 consists of an array of printheads and the print heads move orthogonally to the direction of travel of the tray. Paste station 212, drying station 214 and vacuum station 216 are as explained above, and further drying stations and an inspection station may be added as desired. Numeral 218 indicates an optical inspection system.

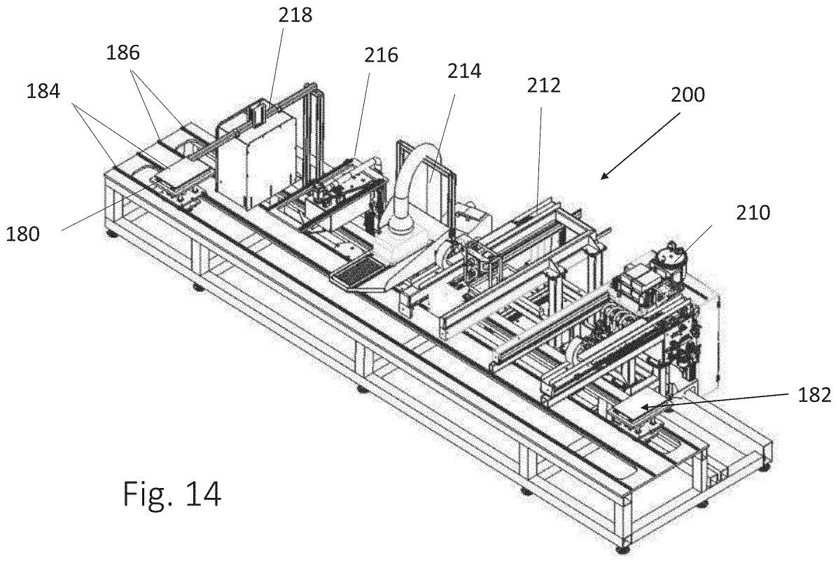

Reference is now made to FIG. 14 which is a variation of the linear embodiment of FIG. 13. Parts that are the same as in FIG. 13 are given the same reference numerals and are not referred to explicitly again except as needed for an understanding of the present embodiment. In the embodiment of FIG. 14, multiple build trays 180, 182 move independently on rails 184, 186, thus allowing for parallel processing of multiple build trays at the same time. The build trays are described in greater detail hereinabove with respect to FIG. 13.

It is expected that during the life of a patent maturing from this application many relevant die slots, pastes, sintering techniques, vacuum techniques, 3D printing technologies and drying techniques will be developed and the scopes of the corresponding and other terms are intended to include all such new technologies a priori.

The terms “comprises”, “comprising”, “includes”, “including”, “having” and their conjugates mean “including but not limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment, and the text is to be construed as if such a single embodiment is explicitly written out in detail. Conversely, various features of the invention, which are, for brevity, described in the context of a single embodiment, may also be provided separately or in any suitable subcombination or as suitable in any other described embodiment of the invention, and the text is to be construed as if such separate embodiments or subcombinations are explicitly set forth herein in detail.

Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated by reference in its/their entirety.

1. An additive manufacturing machine for making a part layerwise by firstly using additive manufacture to make a mold to define a space for the layer, and secondly filling the space with a paste to make a layer of the part, the machine comprising:
a frame;
a first, mold forming, station with nozzles configured to form said mold, said first station being attached to said frame; and
a second, paste dispensing, station distanced from said first station, on said frame, with a dispensing die slot for dispensing paste into said space, the machine being configured to operate on a plurality of parts simultaneously, wherein said stations are arranged around a rotating table, said rotating table being rotatably mounted on said frame, and wherein a circumference of said rotating table is supported by said frame, each part being conveyed on said rotating table along a path through respective ones of said stations.

2. The additive manufacturing machine of claim 1, wherein said stations are fixed over said frame.

3. The additive manufacturing machine of claim 2, the stations respectively forming bridges over said path between an inner side of said path and an outer side of said path and wherein said fixing is at said inner and outer sides respectively.

4. The additive manufacturing machine of claim 1, wherein said paste dispensing station comprises a roller preceding said dispensing die slot, and a cutter following said dispensing die slot, the roller configured for leveling said mold to a predetermined level and said cutter being configured to level said paste, the roller and the cutter being mounted at a same level.

5. The additive manufacturing machine of claim 1, wherein said stations are arranged around a circumference.

6. The additive manufacturing machine of claim 5, wherein said stations are arranged such that a rotation of a part around said stations provides a whole number of completed layers for said part.

7. The additive manufacturing machine of claim 5, wherein said rotating table is configured for carrying manufacturing trays between said stations.

8. The additive manufacturing machine of claim 7, wherein said rotating table is connected to said frame via a central axis, the central axis providing rotation to said table.

9. The additive manufacturing machine of claim 8, wherein said rotation is controlled by an indexer to stop said table when said parts are aligned at respective stations.

10. The additive manufacturing machine of claim 7, wherein said circumference of said table is supported vertically from said frame.

11. The additive manufacturing machine of claim 10, wherein said circumference of said table comprises a rail, and said frame comprises cam followers extended upwardly towards said rail, thereby to provide said vertical support.

12. The additive manufacturing machine of claim 11, wherein said cam followers are aligned with said stations, thereby to securely hold said table at each station vertically.

13. The additive manufacturing machine of claim 1, comprising at least one additional paste dispensing station.

14. The additive manufacturing machine of claim 1, comprising a drying station.

15. The additive manufacturing machine of claim 1, comprising a vacuum station.

16. The additive manufacturing machine of claim 1, comprising an observation station.

17. The additive manufacturing machine of claim 16, wherein said observation station is configured to control said machine to remove a layer found to be damaged, for said layer to be rebuilt.

18. The additive manufacturing machine of claim 1, wherein said stations are aligned on a linear path, the linear path traversed by a linear conveyor.

19. The additive manufacturing machine of claim 1, configured to vary the height of the mold so that different layers are of different thicknesses.

20. The additive manufacturing machine of claim 6, wherein said number is greater than one.

21. The additive manufacturing machine of claim 13, wherein said at least one additional paste dispensing station is configured to dispense pastes of different compositions or to form parts made of compound materials.

22. A method of additive manufacture comprising:
Providing a frame;
Providing a rotating table and a pathway around said table, said table rotatably mounted on said frame,
Supporting said table from a circumference thereof,
Providing a plurality of stations along said pathway, said stations being mounted on said frame,
Providing build trays on said table,
Causing said build trays to traverse said rotating pathway while pausing at each station,
Carrying out different stages of additive manufacture at respective ones of said stations in parallel during said pausing, such that a part traversing said pathway is built up layerwise.

23. The method of claim 22, comprising building a mold to enclose a space at one of said stations.

24. The method of claim 23, comprising filling said space with a paste.

25. The method of claim 24, comprising smoothing said paste at a level at which said mold has been smoothed.

26-30. (canceled)
